(19) United States
(12) Patent Application Publication
(10) Pub. No.: US 2025/0005769 A1
(43) Pub. Date: Jan. 2, 2025

(54) SYSTEM AND METHOD FOR GAZE ESTIMATION BASED ON EVENT CAMERAS

(71) Applicant: AMC Corporation, San Jose, CA (US)

(72) Inventor: Shengwei Da, San Jose, CA (US)

(73) Assignee: AMC Corporation, San Jose, CA (US)

(21) Appl. No.: 18/744,337

(22) Filed: Jun. 14, 2024

Related U.S. Application Data
(60) Provisional application No. 63/524,541, filed on Jun. 30, 2023.

(51) Int. Cl. G06T 7/246; G06T 3/40; G06T 7/73

(52) U.S. Cl. CPC G06T 7/246; G06T 3/40; G06T 7/73; G06T 2207/20081; G06T 2207/20084; G06T 2207/20132

(57) ABSTRACT

One embodiment of this disclosure can provide a system and method for estimating user gazes. During operation, the system can obtain an event stream captured by an event camera monitoring movement of a user's eye, generate an event image by accumulating, at a pixel level, events that occurred within a predetermined interval based on the event stream and determining a pixel value of each pixel based on the accumulated events associated with the pixel, and input the event image to a gaze-estimation machine learning model, which generates a first prediction output regarding a direction of the user's eye movement and a second prediction output regarding a speed of the user's eye movement.

### RELATED APPLICATIONS

This disclosure claims the benefit of U.S. Provisional Application No. 63/524,541, Attorney Docket No. AMC23-1003PSP, entitled “GAZE ESTIMATION BASED ON EVENT CAMERAS,” by inventor Shengwei Da, filed 30 Jun. 2023, the disclosure of which is incorporated herein by reference in its entirety for all purposes.

### BACKGROUND

### Field

The disclosed embodiments generally relate to gaze-tracking technologies. More specifically, the disclosed embodiments relate to estimating gazes using data obtained by event cameras.

### Related Art

Eye tracking or gaze tracking is one of the most crucial technologies in Human-Computer Interaction (HCI) and its applications. For example, gaze tracking can enhance the HCI user interfaces by allowing users to interact with devices using their gaze, such as selecting items or scrolling through content. In Augmented Reality (AR) and Virtual Reality (VR) environments, gaze tracking can contribute to a more immersive experience by allowing the system to respond to where the user is looking, thus enhancing realism and interaction. In autonomous driving environments, it can be used to detect driver drowsiness to enhance safety. Gaze tracking can also be used in human behavior research to understand cognitive processes, attention, and decision-making by analyzing where individuals focus their attention.

Gaze tracking systems typically use cameras and sensors to monitor eye movements and determine the point where a person is looking. For example, many VR/AR devices can include cameras (e.g., visible light or infrared cameras) installed internally to capture images of the user's eyes, and image features such as the shape and position of the pupil, eyelashes, and eye corners can be used to estimate the gaze direction and fixation point. However, conventional gaze-estimation algorithms are complex and are often constrained by the frame rate of the camera.

### SUMMARY

One embodiment of this disclosure can provide a system and method for estimating user gazes. During operation, the system can obtain an event stream captured by an event camera monitoring movement of a user's eye, generate an event image by accumulating, at a pixel level, events that occurred within a predetermined interval based on the event stream and determining a pixel value of each pixel based on the accumulated events associated with the pixel, and input the event image to a gaze-estimation machine learning model, which generates a first prediction output regarding a direction of the user's eye movement and a second prediction output regarding a speed of the user's eye movement.

In a variation on this embodiment, the system can train the gaze-estimation machine learning model using a plurality of annotated event images. A respective annotated event image comprises position annotations and movement annotations.

In a further variation, the position annotations indicate a pupil position, an eye-socket position, and positions of eye corners; and the movement annotations indicate a direction and a speed.

In a further variation, training the gaze-estimation machine learning model can include training a first feature-extraction neural network to extract a first set of features used for predicting the pupil position and the eye-socket position.

In a further variation, training the first feature-extraction neural network can include applying an L2 loss function.

In a further variation, the system can generate a pupil image by cropping and resizing the event image based on the predicted pupil position and generate an eye-socket image by cropping and resizing the event image based on the predicted eye-socket position.

In a further variation, the system can train a second feature-extraction neural network to extract a second set of features from the pupil image and train a third feature-extraction neural network to extract a third set of features from the eye-socket image.

In a further variation, the system can concatenate the second and third sets of features, input the concatenated second and third sets of features to a fourth feature-extraction neural network, and train the fourth feature-extraction neural network to extract a fourth set of features used for predicting the direction of the user's eye moment.

In a further variation, the system can further concatenate the second, third, and fourth sets of features, input the concatenated second, third, and fourth sets of features to a fifth feature-extraction neural network, and train the fifth feature-extraction neural network to extract a fifth set of features used for predicting the speed of the user's eye moment.

In a further variation, training the fourth or fifth feature-extraction neural network comprises applying a binary cross-entropy loss function.

### DESCRIPTION OF THE FIGURES

FIG. 1A and FIG. 1B illustrate exemplary event images corresponding to rightward and leftward eyeball rotations, respectively, according to one embodiment of the instant application.

FIG. 1C and FIG. 1D illustrate exemplary event images corresponding to upward and downward eyeball rotations, respectively, according to one embodiment of the instant application.

FIG. 1E illustrates an exemplary event image corresponding to a slow eyeball rotation toward the upper-right direction, according to one embodiment of the instant application.

FIG. 2 illustrates an exemplary pair of AR glasses with an event camera, according to one embodiment of the instant application.

FIG. 3A illustrates an exemplary annotated event image, according to one embodiment of the instant application.

FIG. 3B illustrates an exemplary annotated event image, according to one embodiment of the instant application.

FIG. 4 illustrates an exemplary architecture of a machine learning model for gaze estimation based on event streams, according to one embodiment of the instant application.

FIG. 5 presents a flowchart illustrating an exemplary process for training a machine learning model for estimating the gaze direction and the eye-rotational speed, according to one embodiment of the instant application.

FIG. 6 illustrates an exemplary gaze-estimation process, according to one embodiment of the instant application.

FIG. 7 illustrates an exemplary gaze-estimation system, according to one aspect of the instant application.

FIG. 8 illustrates an exemplary computer system that facilitates gaze estimation, according to one embodiment of the instant application.

In the figures, like reference numerals refer to the same figure elements.

### DETAILED DESCRIPTION

### Overview

This application discloses a method and system for estimating gazes using data obtained by event cameras, which can detect changes and provide an arbitrarily high frame rate. In some embodiments, event streams generated by an event camera observing a user's eye can be visualized as event images. More specifically, events occurring within a predetermined time interval can be accumulated and mapped to ternary pixel values. Distribution of the pixel values can provide information regarding the direction and speed of the eyeball rotation. A machine learning model can be constructed to learn the direction and speed of the eyeball rotation based on input event streams. The model can be trained based on labeled training samples. The training samples can include visualized event images labeled with the position information (e.g., eye socket position, pupil position, positions of the inner and outer eye corners, etc.) and eye movement information (e.g., direction and speed of the eyeball rotation). The loss functions used for training the neural network can include squared error (or L2) loss and binary cross-entropy loss. The model training can include multiple stages. The first stage of training can be performed based on the position labels comprising the eye socket position, pupil position, and inner and outer eye corners; the second stage can be based on labels comprising the eyeball rotational direction; and the third stage can be based on labels comprising the eyeball rotational speed. The trained model can be used to predict, based on input event streams, various eye parameters, including the eye socket position, pupil position, inner and outer eye corners, gaze angle, and eyeball rotational speed.

Gaze Estimation based on Event Cameras

Most conventional cameras can capture images at a fixed frame rate, and a pixel point in a typical two-dimensional image can be represented using its coordinates as (x, y). Event cameras are bio-inspired sensors that differ from conventional frame cameras. Instead of capturing images at a fixed frame rate, event cameras asynchronously measure per-pixel brightness changes and output a stream of events (referred to as an event stream) that encode the time (denoted as t), position (denoted as (x, y)), and sign or polarity (denoted p) of the brightness changes. The polarity is defined as follows: at a time t, if the sensed value at position (x, y) exceeds the sensed value at the same position at the previous time instant t−1, the polarity is 1; otherwise, the polarity is −1. Therefore, the recording format for a specific time and position in the event stream can be (t, x, y, p). Compared to conventional cameras, event cameras can provide a higher temporal resolution and lower latency, a higher dynamic range, and lower power consumption.

The output of event cameras is fundamentally different from that the output of standard cameras: events are asynchronous and spatially sparse, whereas images are synchronous and dense. Moreover, in contrast to the grayscale information that standard cameras provide, an event typically contains binary (increase/decrease) brightness change information. Hence, extracting eye movement information from the output of event cameras can be challenging. In some embodiments of the instant application, the output of an event camera within a predetermined time interval (e.g., a few milliseconds) can be visualized as a 2D image. Eye movement information (e.g., direction and speed) can be extracted from the visualized 2D image (can be referred to as an event image). Moreover, a machine learning technique can be used to learn the mapping between the eye movement and the event image.

In some embodiments, an event image can be created by counting events or accumulating polarity pixel-wise within a predetermined interval and mapping the pixel values (i.e., brightness levels) to the accumulated polarity. In one example, the accumulated polarities of each pixel can be determined by adding the polarity of that pixel within a predetermined interval (e.g., 5 ms). When creating the image, the pixel value at a particular pixel position (x, y) can be computed based on:

$${P}_{{t}_{0}} ( x , y ) = \{ \begin{matrix}225 , & {p}_{{t}_{0}} ( x , y ) > 0 \\ 0 , & {P}_{{t}_{0}} ( x , y ) < 0 \\ 127 , & others\end{matrix} ,$$

$$where {P}_{{t}_{0}} ( x , y ) denotes the pixel value , and$$

pₜ_{₀}(x, y) denotes the accumulated polarities. For example, if three events occur within a predetermined interval, and each event results in a +1 polarity at a particular pixel, the accumulated polarities at that pixel are +3, resulting in the pixel value being 255 (i.e., white). In another example, among the three events that occurred within the predetermined interval, two events resulted in a +1 polarity, and one event resulted in a −1 polarity. The accumulated polarities at that pixel are −1, and the pixel value would be 0 (i.e., black). In yet another example, no event occurred within the predetermined interval, resulting in the accumulated polarities being zero, and the pixel value being 127 (i.e., gray). In the above expression, the pixel value can have three possible levels (i.e., 0, 127, and 255, corresponding to black, gray, and white, respectively). In practice, the pixel value can also have more than three levels (e.g., four or five levels).

Eye movement (i.e., the rotation of the eyeball) can be derived from the event image. More specifically, the distribution of white and black pixels and their numbers can provide information regarding the direction and speed of the rotation of the eyeball. Note that the direction of the rotation of an eye in an image can be opposite to that in the real world. For example, if an eye appears to rotate leftward in the image, it corresponds to the eye rotating rightward in the real world. Throughout this disclosure, directions of the eye rotation are defined with respect to images.

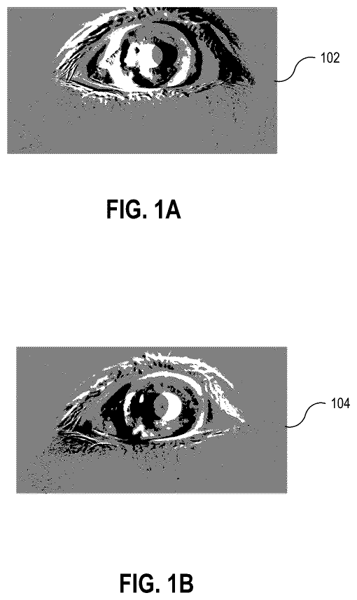

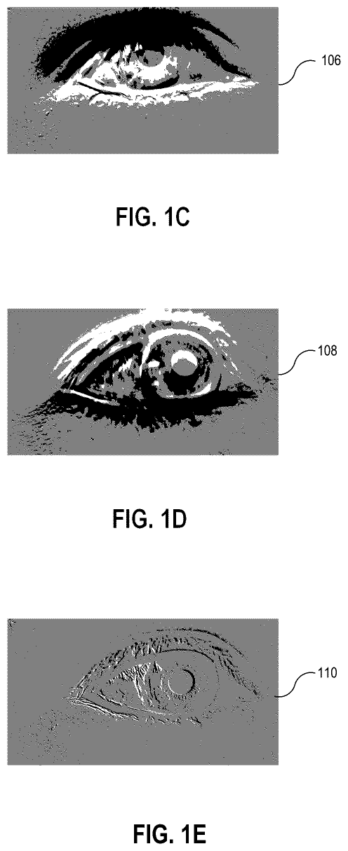

FIG. 1A and FIG. 1B illustrate exemplary event images corresponding to rightward and leftward eyeball rotations, respectively, according to one embodiment of the instant application. As shown in FIG. 1A, when the eyeball rotates to the right (with respect to the image), due to the stronger light reflection by the sclera (i.e., the white of the eye), more events with a positive polarity can occur on the left side of the eye, creating more pixels with a pixel value of 255 on the left side of the eye socket in event image 102. On the other hand, the weaker light reflection of the eyeball (including the iris and pupil) can cause more events with a negative polarity to occur on the right side of the eye, creating more pixels with a pixel value of 0 on the right side of the eye socket in event image 102. In other words, event image 102 shows a larger bright area on the left side and a larger dark area on the right side.

In FIG. 1B, the eyeball rotates to the left. Accordingly, more events with a positive polarity can occur on the right side of the eye, creating more pixels with a pixel value of 255 on the right side of the eye socket in event image 104; and more events with a negative polarity can occur on the left side of the eye, creating more pixels with a pixel value of 0 on the left side of the eye socket in event image 104. In other words, event image 104 shows a larger bright area on the right side and a larger dark area on the left side.

FIG. 1C and FIG. 1D illustrate exemplary event images corresponding to upward and downward eyeball rotations, respectively, according to one embodiment of the instant application. In the example shown in FIG. 1C, the eyeball rotates upward. Accordingly, more events with a positive polarity can occur at the lower portion of the eye, resulting in event image 106 showing an eye with a brighter lower portion and a darker upper portion. In the example shown in FIG. 1D, the eyeball rotates downward. Accordingly, more events with a positive polarity can occur at the upper portion of the eye, resulting in event image 108 showing an eye with a brighter upper portion and a darker lower portion.

As shown in FIGS. 1A-1D, the distribution of the bright and dark (or white and black) areas can indicate the rotation direction of the eyeball. More specifically, the rotation direction of the eyeball typically points from the bright (or white) regions to the dark (or black) regions in the event image. In addition to direction, gaze estimation also requires information about the rotational speed of the eyeball. In some embodiments of the instant application, information about the eyeball rotational speed can be extracted from the event image based on the sizes of the bright (e.g., white) and dark (e.g., black) regions. More specifically, the faster the eyeball rotates, the larger the areas of dark or bright regions, and the smaller the area of the gray region in the event image, because faster eyeball rotation can result in more events (including both the events with a positive polarity and the events with a negative polarity) occur in the eye region. More positive events can lead to larger bright regions, and more negative events can lead to larger darker regions in the event image. In contrast, slow eyeball movement can result in fewer events. Therefore, the slower the eyeball rotates, the smaller the size of the dark or bright regions, and the larger the size of the gray region in the event image.

FIG. 1E illustrates an exemplary event image corresponding to a slow eyeball rotation toward the upper-right direction, according to one embodiment of the instant application. As can be seen in FIG. 1E, in event image 110, most regions in the eye socket appear gray, indicating that fewer events have occurred in those regions within the predetermined interval. The few bright regions are located on the left and lower part of the eye, indicating that the eyeball is moving toward the upper-right direction.

To capture events associated with eye movement, an event camera can be placed near the eye, such as at a distance between two and four centimeters, to have a clear view of the eye. In some embodiments of the instant application, the event camera can be part of a wearable device (e.g., a virtual reality (VR) headset or a pair of augmented reality (AR) glasses). In one example, the event camera can be mounted at the lower rim of a pair of AR glasses.

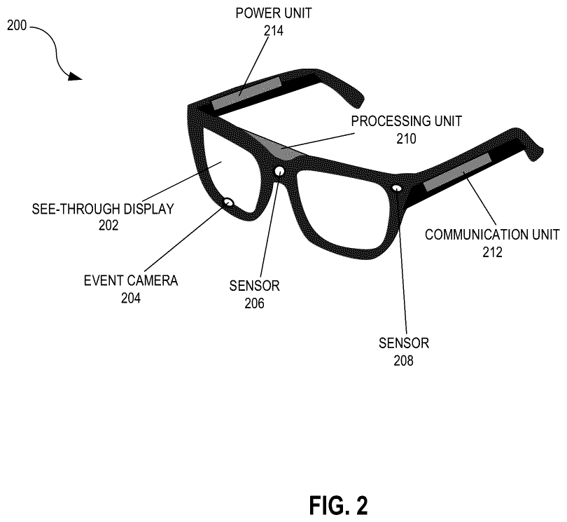

FIG. 2 illustrates an exemplary pair of AR glasses with an event camera, according to one embodiment of the instant application. FIG. 2 shows that AR glasses 200 can have a similar appearance as a pair of regular glasses and can include a frame and a pair of lenses. At least one of the lenses can be a see-through display (e.g., see-through display 202). AR glasses 200 can include an event camera 204 mounted at the lower rim of see-through display 202.

FIG. 2 also shows that AR glasses 200 can include a number of sensors mounted at various locations of the frame, such as sensors 206 and 208. AR glasses can also include a processing unit 210, a communication unit 212, and a power unit 214.

While a user is wearing AR glasses 200, event camera 204 can capture an event stream (with each event in the format of (t, x, y, p)) associated with the user's eye movement. Processing unit 210 can process the event stream to create event images. In some embodiments, an event image can be created by accumulating events that occur within a predetermined interval. In one embodiment, the predetermined interval can be between 2 and 10 milliseconds (e.g., 5 ms). In a further embodiment, the event-accumulation interval can be adjusted dynamically. For slow-varying events, the event-accumulation interval can be longer, and for fast-varying events, the event-accumulation interval can be shorter. The event images can be displayed on see-through display 202. In alternative embodiments, the event stream and/or images can be transmitted, by communication unit 212, to a remote server, which can process the event stream and display event images on an associated display. Power unit 214 can provide power to the various embedded electronic devices of AR glasses 200.

Note that the placement of the different components of AR glasses 200 shown in FIG. 2 is exemplary; depending on the design, different arrangements of the components can also be possible. In addition, AR glasses 200 can also include more or fewer components than those shown in FIG. 2.

### The Model Training

The event images shown in FIGS. 1A-1E can be labeled or annotated with the rotational direction and speed of the eyeball, and the labeled images can be used to train a machine learning model for gaze estimation. The training starts with the generation and annotation of the event images.

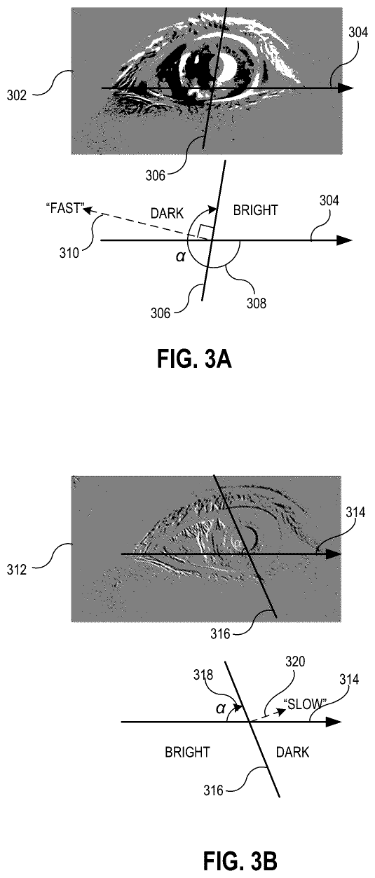

FIG. 3A illustrates an exemplary annotated event image, according to one embodiment of the instant application. Event image 302 shown in FIG. 3A can be similar to event image 104 shown in FIG. 1B, in which the eyeball rotates leftwards. Annotating event image 302 can involve annotating various feature points (e.g., the eye socket, pupil, and corners of the eye). In some embodiments, these feature points can be manually annotated by a human user using an annotation tool. In alternative embodiments, object-detection techniques can be used to automatically detect and annotate these feature points.

The gaze direction (or the direction of the rotation of the eyeball) can be determined based on the detected feature points and the distributions of the bright and dark regions within the pupil. In one embodiment, annotating the gaze direction can include drawing a line connecting the two outer corners of the eye as a horizontal reference axis 304 and drawing a line that separates the light and dark (or black and white) regions within the pupil as a boundary line 306. For a better viewing effect, lines 304 and 306 are redrawn below event image 302. As shown in FIG. 3A, the bright region of the pupil is on the lower-right side of boundary line 306, whereas the dark region is on the upper-left side. The segment of horizontal reference axis 304 on the bright side and the segment of boundary line 306 above reference axis 304 form an angle α, the value of which can be used to indicate the direction of the eye rotation. More specifically, a can be formed by rotating the bright-side segment of horizontal reference axis 304 clockwise until it overlaps with the upper segment of boundary line 306. In the example shown in FIG. 3A, a is between 270° and 360°, which corresponds to an upper-left movement direction. Another way to annotate the rotation direction is to draw an arrow (e.g., arrow 310) that points from the bright region toward the dark region and is perpendicular to boundary line 306.

The rotational speed of the eyeball can be determined based on the sizes of the bright and dark regions. In some embodiments, annotating the eye rotational speed can include segmenting the region where the pupil rotates and fitting changes of the pupil region over time to obtain statistics of the sizes of the bright and dark (or white and black) regions. Normalization can also be performed on the sizes of the bright and dark regions against the size of the pupil. If the bright and dark regions evenly divide the pupil, the eyeball rotates fast. In one embodiment, when the pupil is evenly divided between bright and dark regions, the event image can be annotated with a maximum rotational speed (e.g., 90°/interval). In one example, the predetermined interval for accumulating the events into an event image is 5 ms, and the maximum rotational speed of the eyeball can be 18°/ms. If the entire pupil region is gray with near-zero bright and dark areas, it can be determined that the eye rotational speed can be near zero. In one embodiment, when the bright or dark region in the pupil is small, the event image can be annotated with a minimum rotational speed (e.g., 0°/interval). Given that the interval is 5 ms, the minimum rotational speed of the eyeball can be 0°/5 ms.

In many cases, the eye rotational speed can be between the maximum and minimum values. In some embodiments, the rotational speed can be computed according to:

$$v = 90 ° \times ( {S}_{white} / ( \frac{{S}_{pupil}}{2} ) ) / interval ,$$

where S_{white} is the size of the bright (or white) area in the pupil, Sₚᵤₚᵢₗ is the size of the pupil. As can be seen from the above formula, the rotational speed can be at its maximum value when the area of the bright region approaches half the size of the pupil, and the rotational speed can be at its minimum value when the area of the bright region approaches zero. In the example shown in FIG. 3A, the bright region occupies about half of the pupil, and the speed annotation can be “fast.” In one embodiment, the length of arrow 310 can be correlated with the determined rotational speed. For example, the length of the arrow annotation can be proportional to the determined rotational speed of the eyeball.

FIG. 3B illustrates an exemplary annotated event image, according to one embodiment of the instant application. Event image 312 shown in FIG. 3A can be similar to event image 110 shown in FIG. 1E, in which the eyeball rotates slowly toward the upper-right direction. FIG. 3B can be similarly annotated as FIG. 3A, where a horizontal reference axis 314 is drawn to connect the eye corners, and a boundary line 316 is drawn to divide the pupil into bright and dark regions. The segment of horizontal reference axis 314 on the bright side and the segment of boundary line 316 above reference axis 314 form an angle 318 (i.e., α). In this example, α is between 0° and 90°, which corresponds to an upper-right movement direction. Note that an a value between 90° and 180° corresponds to a lower-right eye movement direction, and an a value between 180° and 270° corresponds to a lower-left eye movement direction. Moreover, FIG. 3B shows that there is a minimum bright or dark region within the pupil. Accordingly, the eye rotational speed can be annotated as “slow” or using a shorter arrow 320.

The annotated event images can be used to train a machine learning model to predict the rotational direction and speed of the eye movement based on event images (or event streams). In some embodiments, the machine learning model can include a deep learning neural network. Because the model needs to learn different types of variables (e.g., positions of various eye feature points, eyeball rotation direction, and eyeball rotational speed), the training process can include multiple stages, and each stage can be used to optimize the model parameters based on one subset of the labels.

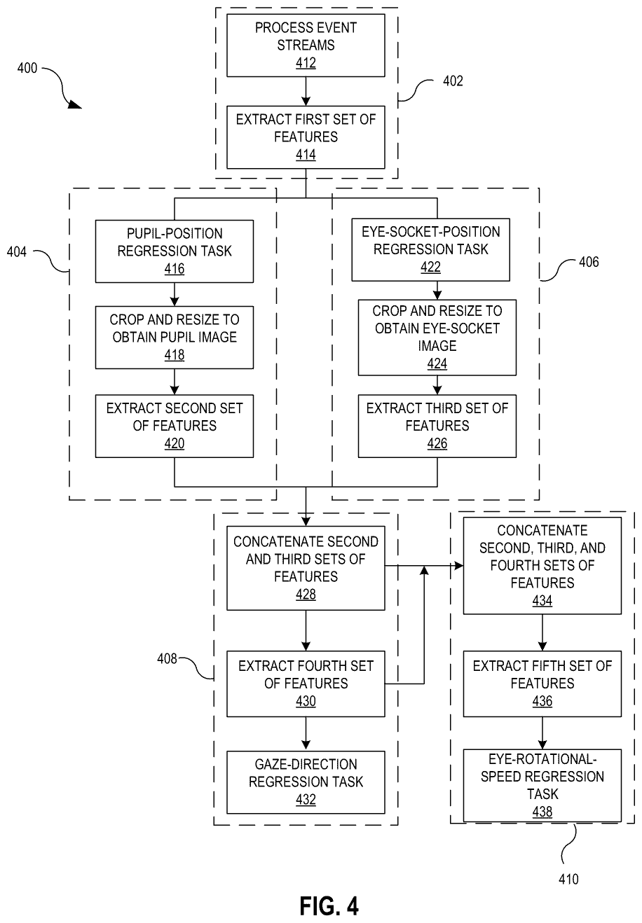

FIG. 4 illustrates an exemplary architecture of a machine learning model for gaze estimation based on event streams, according to one embodiment of the instant application. In FIG. 4, a machine learning model 400 can include multiple stages, such as an event-stream-processing stage 402, a pupil-feature-extraction stage 404, a socket-feature-extraction stage 406, a gaze-direction regression stage 408, and an eye-rotational-speed regression stage 410. Each stage can include a number of machine learning tasks that are performed in series. Operations in different stages may be performed in series or parallel. In the example shown in FIG. 4, event-stream-processing stage 402 can be in series with pupil-feature-extraction stage 404 or socket-feature-extraction stage 406, and pupil-feature-extraction stage 404 and socket-feature-extraction stage 406 can be parallel stages. Similarly, gaze-direction regression stage 408 and eye-rotational-speed regression stage 410 can be parallel stages.

Event-stream-processing stage 402 can include various components and units for performing tasks associated with processing the event streams captured event cameras, including a task 412 for processing the event streams to generate event images and a task 414 for extracting a first set of features from the event images. As discussed previously, an event image can be generated by accumulating events that occur within a predetermined interval and mapping the accumulated polarities at each pixel position to a pixel value. The first set of features can be extracted from the event image and can include features that can be used to detect the pupil and/or eye socket. Exemplary features can include contours, contrasts, brightness, etc. In some embodiment, the first set of features can be extracted using a convolutional neural network (CNN).

Pupil-feature-extraction stage 404 can include various components and units used for performing tasks associated with extracting features from pupil images, including a pupil-position regression task 416, a task 418 for cropping and resizing the event image to obtain a pupil image, and a task 420 for extracting a second set of features from the pupil image. In some embodiments, pupil-position regression task 416 can be performed using a neural network (e.g., a residual neural network or ResNet), which has been previously trained using labeled event images. More specifically, the labels of each event image can include a label indicating the position of the pupil. Task 418 can include the process of cropping the event image based on a bounding box surrounding the pupil region and the process of resizing the image to a predetermined size (e.g., a size of 112×56). In one embodiment, cropping the image can include extending, from the edge of the detected pupil bounding box, the bounded pupil region by a predetermined number of pixels (e.g., 20 pixels) in each direction and then cropping the extended pupil region. Like the first set of features, the second set of features can also be extracted using a CNN.

The structure of socket-feature-extraction stage 406 can be similar to pupil-feature-extraction stage 404 and can include various components and units used for performing tasks associated with extracting features from eye-socket images, including an eye-socket-position regression task 422, a task 424 for cropping and resizing the event image to obtain an eye-socket image, and a task 426 for extracting a third set of features from the eye-socket image. In some embodiments, eye-socket-position regression task 422 can be performed using a neural network, which has been previously trained using labeled event images. More specifically, the labels of each event image can include information regarding the position of the eye socket, such as the positions of the eye corners and the positions of the upper and lower eye lids. Task 424 can be similar to task 418 and can include the process of cropping and resizing the event image to obtain an eye-socket image of a predetermined size (e.g., a size of 224×112). The units for performing tasks 418 and 424 can be configured such that the size of the pupil image is smaller than the size of the eye-socket image. In one embodiment, the eye-socket image can be obtained by extending, from the edge of the detected eye-socket bounding box, the bounded eye-socket region by a predetermined number of pixels (e.g., 20 pixels) in each direction and then cropping the extended eye-socket region. Like the first and second sets of features, the third set of features can also be extracted using a CNN. Note that the three sets of features are extracted from different images with different resolutions, thus capable of providing feature information on different scales. For example, the first set of features is extracted from the original event image and can provide feature information on a coarse scale, such as geometric shapes. The second and third sets of features are extracted, respectively, from the pupil and eye-socket images and can provide feature information about the pupil and eye-socket regions on a much finer scale.

In the example shown in FIG. 4, gaze-direction regression stage 408 and eye-rotational-speed regression stage 410 have similar structures and are in parallel with each other. More specifically, gaze-direction regression stage 408 can include a task 428 for concatenating the second and third sets of features, a task 430 for extracting a fourth set of features from the concatenated data, and a gaze-direction regression task 432. Because the second set of features is extracted from a smaller image (i.e., the pupil image) than the third set of features, task 426 can include an additional down-sampling operation to ensure that the second and third sets of features are of the same size and can be concatenated to form a new set of data. The fourth set of features can be extracted, via a CNN, from the concatenation of the second and third set of features. Gaze-direction regression task 432 can be performed using a neural network that was trained using event images labeled with the gaze direction (e.g., left, right, up, down, upper-left, upper-right, lower-left, lower-right, etc.). The gaze direction may also be in the form of an angle (e.g., the angle α shown in FIG. 3A and FIG. 3B) or an arrow. Gaze-direction regression task 432 can output an estimated gaze vector associated with an event image.

Eye-rotational-speed regression stage 410 can include a task 434 for concatenating the second, third, and fourth sets of features, a task 436 for extracting a fifth set of features from the concatenated data generated by task 434, and an eye-rotation-speed regression task 432. The down-sampled third set of features and the third and fourth sets of features have the same size and can be concatenated to form a new feature set. The fifth set of features can then be extracted, via a CNN, from the concatenation of the second, third, and fourth feature sets. Eye-rotational-speed regression task 438 can be performed using a neural network that was trained using event images labeled with the rotational speed of the eyeballs (e.g., fast and slow). The rotational speed may also be in the form of an angular speed (e.g., degrees per interval). Eye-rotational-speed regression task 438 can output an estimated rotational speed of the eye associated with an event image. In some embodiments, the estimated gaze direction and eye-rotational speed can be output by the multi-stage neural network simultaneously for the same input data.

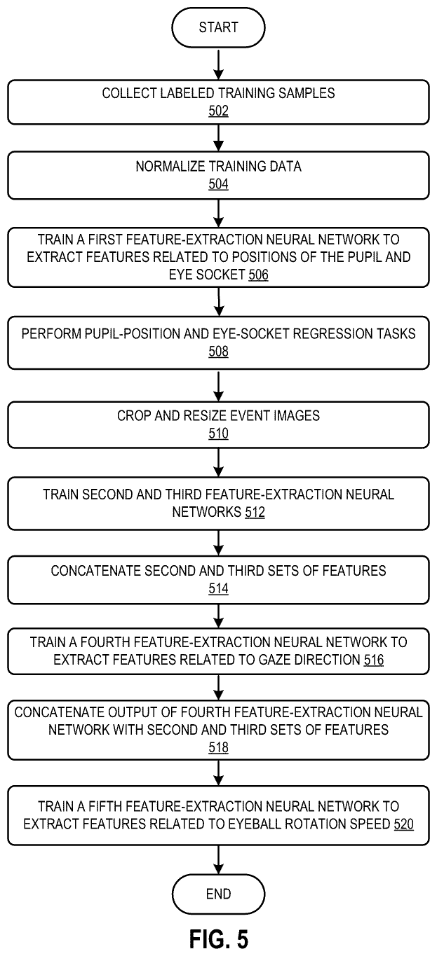

FIG. 5 presents a flowchart illustrating an exemplary process for training a machine learning model for estimating the gaze direction and the eye-rotational speed, according to one embodiment of the instant application. In one or more embodiments, one or more of the steps in FIG. 5 may be repeated and/or performed in a different order. Accordingly, the specific arrangement of steps shown in FIG. 5 should not be construed as limiting the scope of the technique.

The training can start with collecting labeled training samples (operation 502). Collecting the labeled training samples can include generating event images from event data captured by event cameras and annotating the event images. In some embodiments, the event camera can be mounted on the rim of a pair of AR glasses to capture eye-rotation events. Generating an event image can include accumulating, at the pixel level, events that occurred within a predetermined interval and then mapping the accumulated polarity into discrete pixel values. In one embodiment, if the accumulated polarities at a pixel position are positive, the corresponding pixel value can be set as 255; if the accumulated polarities at a pixel position are negative, the corresponding pixel value can be set as 0; otherwise, the corresponding pixel value can set as 127. The event images can be annotated manually by a human user or automatically using a machine-learning-based annotation tool. The annotation can include position information regarding the pupil, corners of the eye, and upper and lower lids; direction information regarding the eyeball rotation; and speed information regarding the eyeball rotation. In one embodiment, the system can obtain 180,000 annotated event images, with 140,000 images used as the training set, 20,000 images used as the validation set, and the remaining 20,000 images used as the testing set.

The training data (i.e., pixel values of the event images) can be normalized (operation 504). For example, the pixel value at position (x, y) can be normalized according to p (x, y)=p (x, y)/255. After normalization, all values in the training data set can be in the range of [0,1].

The normalized training data can be used to train a first feature-extraction neural network (e.g., a first CNN) that can be used to extract features related to the positions of the pupil and eye socket (operation 506). In some embodiments, the training can be performed using a gradient-based algorithm, such as the Adam (Adaptive Moment Estimation) algorithm. In one example, the training can be performed using an Adam optimizer with a momentum of 0.9. The loss function used during training can include an L2 loss (i.e., the squared error loss) function. The training can be performed for 100 epochs, and model parameters with the best performance can be recorded.

The trained first feature-extraction neural network (i.e., using the model parameters with the best performance) can be used to perform the pupil position and eye-socket position regression tasks (operation 508). Based on the inferred pupil position and eye-socket position, the system can crop and resize the event images to obtain pupil images and eye-socket images (operation 510). In one embodiment, cropping an event image can include expanding the bounding box around the pupil or eye socket by a predetermined number of pixels in each direction to obtain a slightly larger box and then cropping the image along the edges of the larger box. The cropped image can then be resized (which may include up-sampling or down-sampling the pixel values) to a predetermined size. The resized eye-socket image is typically larger than the resized pupil image. In one embodiment, after resizing, the eye-socket image can have a size of 224×112, and the pupil image can have a size of 112×56.

The pupil images and eye-socket images can be used to train, respectively, second and third feature-extraction neural networks (operation 512). The second and third feature-extraction neural networks can include CNNs and can be used to extract the second and third set of features useful in the determination of the eye movement direction and speed. The second feature-extraction neural network can include an additional down-sampling operation to ensure that its output can have the same size (i.e., the same height and width) as the output of the third feature-extraction neural network.

The system can concatenate the second and third sets of features (operation 514) and use the concatenated feature vectors to train a fourth feature-extraction neural network to output a fourth set of features related to the gaze direction (operation 516). In some embodiments, the training can be performed using an Adam optimizer with a momentum of 0.9, and the loss function used during training can include a binary cross-entropy loss function. In one example, the training can be performed for 50 epochs, and model parameters with the best performance can be recorded.

The output of the fourth feature-extraction neural network can be concatenated with the previously concatenated second and third sets of features (operation 518). The system can further train a fifth feature-extraction neural network to output a fifth set of features related to the eyeball rotational speed (operation 520). In some embodiments, the training can be performed using an Adam optimizer with a momentum of 0.9, and the loss function used during training can include a binary cross-entropy loss function. In one example, the training can be performed for 50 epochs, and model parameters with the best performance can be recorded. At this point, all feature-extraction neural networks have been trained, and these trained networks can form a large gaze-estimation model that can be used to make predictions regarding the eyeball rotational direction and speed based on new event data. In the example shown in FIG. 5, the model can include up to five feature-extraction networks that can be trained to extract features under different scales and using different semantics. In practice, the model can include more or fewer feature-extraction networks depending on the complexity of the scene and the computational power of the deployment platform.

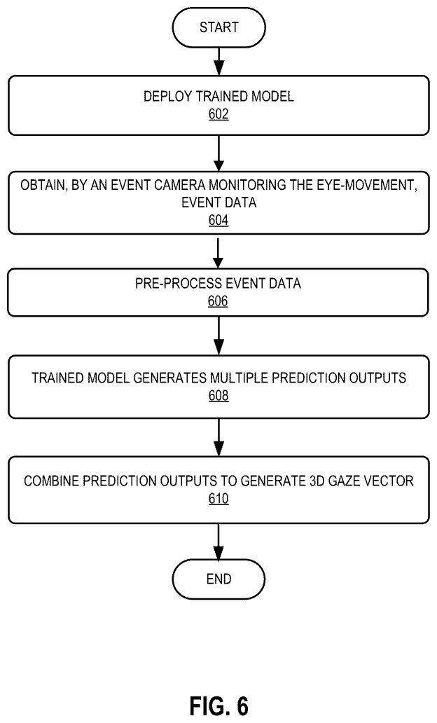

FIG. 6 illustrates an exemplary gaze-estimation process, according to one embodiment of the instant application. In one or more embodiments, one or more of the steps in FIG. 6 may be repeated and/or performed in a different order. Accordingly, the specific arrangement of steps shown in FIG. 6 should not be construed as limiting the scope of the technique.

During operation, the trained model can be deployed (operation 602). In some embodiments, the trained model can include a number of neural networks, including at least a neural network for predicting the pupil and eye-socket positions, a neural network for extracting features from pupil images, a neural network for extracting features from eye-socket images, a neural network for predicting the eye-rotation direction, and a neural network for predicting the eye-rotational speed. The trained model can be deployed to the cloud as a cloud application or to edge devices.

Event data can be obtained by an event camera monitoring the eye movement (operation 604). Depending on the application, the event data can be obtained online or offline. In one example, the event camera can be mounted on a wearable device with a clear view of the user's eye. The event data can be pre-processed (operation 606). Pre-processing the event data can include generating image data by accumulating events that occur in predetermined intervals and mapping accumulated polarity to pixel values. There is no longer the need to visualize (e.g., via a display) the event data into images. The image data (i.e., pixel values) can be used directly as input to the trained model. The visualization is only needed during the annotation. Pre-processing the event data can further include normalizing the pixel values. In one example, after normalization, the pixel values can be in the range between zero and one.

The pre-processed event data can be used as the input to the trained model (operation 606). The trained model can generate a number of prediction outputs, including predicted pupil position, eye-socket position, positions of the eye corners, the direction of the eye rotation, and the speed of the eye rotation (operation 608).

The above prediction outputs can be combined to generate a three-dimensional (3D) gaze vector in a target coordinate system (operation 610). In one embodiment, generating the 3D gaze vector can involve determining the transformation between the world coordinate system and the camera coordinate system.

### The System

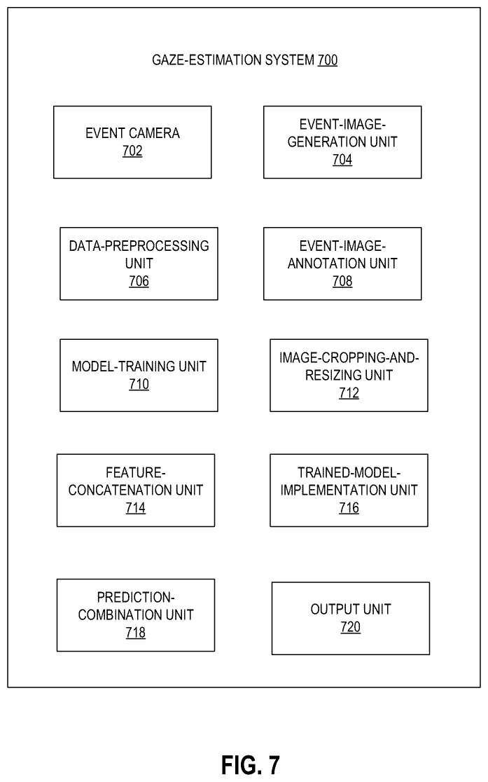

FIG. 7 illustrates an exemplary gaze-estimation system, according to one aspect of the instant application. In FIG. 7, a gaze-estimation system 700 can include an event camera 702, an event-image-generation unit 704, a data-preprocessing unit 706, an event-image-annotation unit 708, a model-training unit 710, an image-cropping-and-resizing unit 712, a feature-concatenation unit 714, a trained-model-implementation unit 716, a prediction-combination unit 718, and an output unit 720. These units can be implemented using hardware, software, or a combination thereof.

Event camera 702 can output a stream of events related to a user's eye movement. In some embodiments, event camera 702 can be embedded in the frame of a pair of AR glasses or a VR headset. Event-image-generation unit 704 can generate event images or event-image data based on the event stream. In some embodiments, an event image can be generated by accumulating, at the pixel level, events that occurred within a predetermined time interval and then mapping the accumulated polarities to pixel values.

Data-preprocessing unit 706 can be responsible for pre-processing the image data. In some embodiments, data-preprocessing unit 706 can normalize the pixel values. Event-image-annotation unit 708 can be responsible for annotating event images to be used as training samples. More specifically, the annotation can include position labels (e.g., positions of the pupil, eye socket, eye corners, etc.), eye-rotational-direction labels, and eye-rotational-speed labels.

Model-training unit 710 can be responsible for training a machine learning model based on labeled training samples. More specifically, the machine learning model can include multiple neural networks that can be trained separately and in parallel to perform different regression tasks, including the pupil-position regression task, the eye-socket-position regression task, the eye-rotation-direction regression task, and the eye-rotation-speed regression task. Image-cropping-and-resizing unit 712 can be responsible for cropping and resizing the event images based on the predicted pupil and eye-socket positions. Image-cropping-and-resizing unit 712 can output pupil images containing the pupil region of the eye and eye-socket images containing the eye-socket region of the eye. The resized pupil images are typically smaller than the resized eye-socket images. Feature-concatenation unit 714 can be responsible for concatenating the feature sets extracted by multiple (e.g., two or three) neural networks to generate a feature set that can be used as an input to the neural network for estimating the eye-rotation direction or eye-rotational speed.

Trained-model-implementation unit 716 can be responsible for implementing the trained model to estimate a user's gaze based on newly captured event data. For example, an event camera embedded in a pair of AR glasses can output an event stream associated with the user's eye movement and send the event stream to trained-model-implementation unit 716, which can input the event stream into the trained model and obtain a number of prediction outputs, include the prediction of the pupil position, the prediction of the eye-socket position, the prediction of the positions of the eye corners, the prediction of the eye-rotation direction, and the prediction of the eye-rotational speed. Prediction-combination unit 718 can be responsible for combining the aforementioned multiple predictions to generate a 3D gaze vector. Output unit 720 can be responsible for outputting the 3D gaze vector.

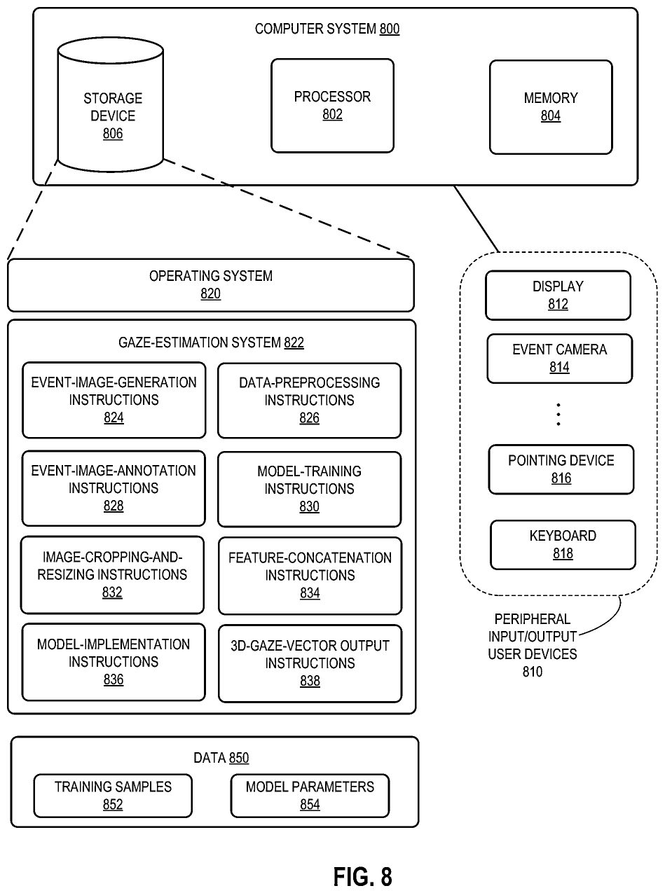

FIG. 8 illustrates an exemplary computer system that facilitates gaze estimation, according to one embodiment of the instant application. Computer system 800 includes a processor 802, a memory 804, and a storage device 808. Furthermore, computer system 800 can be coupled to peripheral input/output (I/O) user devices 810, e.g., a display 812, an event camera 814, a pointing device 816, and a keyboard 818. Storage device 806 can store an operating system 820, a gaze-estimation system 822, and data 850.

Gaze-estimation system 822 can include instructions, which when executed by computer system 800, can cause computer system 800 or processor 802 to perform methods and/or processes described in this disclosure. Specifically, gaze-estimation system 822 can include instructions for generating event images based on outputs of event cameras (event-image-generation instructions 824), instructions for pre-processing the image data (data-preprocessing instructions 826), instructions for annotating the event images (event-image-annotation instructions 828), instructions for training a machine learning model comprising multiple neural networks (model-training instructions 830), instructions for cropping and resizing images (image-cropping-and-resizing instructions 832), instructions for concatenating feature sets (feature-concatenation instructions 834), instructions for implementing the trained model (model-implementation instructions 836), and instructions for combining multiple predictions to output a 3D gaze vector (3D-gaze-vector output instructions 838). Data 850 can include training samples 852 and model parameters 854.

This disclosure describes a system and method for gaze estimation based on event data provided by event cameras. An event camera can be mounted on a pair of AR glasses to collect event data associated with a user's eye movement. The event data can be converted into event images. An event image can be generated by accumulating, at the pixel level, events that occurred within a predetermined interval and then mapping the accumulated polarity at each pixel position to a discrete pixel value. In one example, the pixel values can have three levels: black, white, and gray, resulting in dark, bright, and gray regions in each event image. The distribution and ratio of the dark and bright regions in the pupil can indicate the direction and speed, respectively, of the eye rotation. In some embodiments, the event images can be annotated, either manually or automatically, with both the position information and the eyeball rotation information. The position information can include the positions of the pupil, eye socket, corners of the eye, etc. The eyeball rotation information can include rotational direction and speed information.

The annotated event images can be used to train a machine learning model that comprises multiple neural networks, including at least a neural network for predicting the position information, a neural network for predicting the eyeball rotational direction, and a neural network for predicting the eyeball rotational speed. Moreover, the machine learning model can include two additional feature-extraction neural networks, one for extracting a set of features from a cropped event image comprising the pupil region and one for extracting a set of features from a cropped event image comprising the eye socket region. The two sets of features can be concatenated and used as input to the neural network for predicting the eyeball rotational direction. Moreover, features related to the eyeball rotation direction can be concatenated with the above two sets of features and used as input to the neural network for predicting the eyeball rotational speed.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method, comprising:
obtaining an event stream captured by an event camera monitoring movement of a user's eye;
generating an event image by accumulating, at a pixel level, events that occurred within a predetermined interval based on the event stream and determining a pixel value of each pixel based on the accumulated events associated with the pixel; and
inputting the event image to a gaze-estimation machine learning model, which generates a first prediction output regarding a direction of the user's eye movement and a second prediction output regarding a speed of the user's eye movement.

2. The method of claim 1, further comprising training the gaze-estimation machine learning model using a plurality of annotated event images, wherein a respective annotated event image comprises position annotations and movement annotations.

3. The method of claim 2, wherein the position annotations indicate a pupil position, an eye-socket position, and positions of eye corners, and wherein the movement annotations indicate a direction and a speed.

4. The method of claim 2, wherein training the gaze-estimation machine learning model comprises training a first feature-extraction neural network to extract a first set of features used for predicting the pupil position and the eye-socket position.

5. The method of claim 4, wherein training the first feature-extraction neural network comprises applying an L2 loss function.

6. The method of claim 4, further comprising:
generating a pupil image by cropping and resizing the event image based on the predicted pupil position; and
generating an eye-socket image by cropping and resizing the event image based on the predicted eye-socket position.

7. The method of claim 6, wherein training the gaze-estimation machine learning model comprises:
training a second feature-extraction neural network to extract a second set of features from the pupil image; and
training a third feature-extraction neural network to extract a third set of features from the eye-socket image.

8. The method of claim 7, further comprising:
concatenating the second and third sets of features;
inputting the concatenated second and third sets of features to a fourth feature-extraction neural network; and
training the fourth feature-extraction neural network to extract a fourth set of features used for predicting the direction of the user's eye moment.

9. The method of claim 8, further comprising:
concatenating the second, third, and fourth sets of features;
inputting the concatenated second, third, and fourth sets of features to a fifth feature-extraction neural network; and
training the fifth feature-extraction neural network to extract a fifth set of features used for predicting the speed of the user's eye moment.

10. The method of claim 9, wherein training the fourth or fifth feature-extraction neural network comprises applying a binary cross-entropy loss function.

11. A non-transitory computer readable storage medium storing instructions which, when executed by a processor, causes the processor to perform a method, the method comprising:
obtaining an event stream captured by an event camera monitoring movement of a user's eye;
generating an event image by accumulating, at a pixel level, events that occurred within a predetermined interval based on the event stream and determining a pixel value of each pixel based on the accumulated events associated with the pixel; and
inputting the event image to a gaze-estimation machine learning model, which generates a first prediction output regarding a direction of the user's eye movement and a second prediction output regarding a speed of the user's eye movement.

12. The non-transitory computer readable storage medium of claim 11,
wherein the method further comprises training the gaze-estimation machine learning model using a plurality of annotated event images;
wherein a respective annotated event image comprises position annotations and movement annotations;
wherein the position annotations indicate a pupil position, an eye-socket position, and positions of eye corner; and
wherein the movement annotations indicate a direction and a speed.

13. The non-transitory computer readable storage medium of claim 12, wherein training the gaze-estimation machine learning model comprises training a first feature-extraction neural network to extract a first set of features used for predicting the pupil position and the eye-socket position.

14. The non-transitory computer readable storage medium of claim 13, wherein the method further comprises:
generating a pupil image by cropping and resizing the event image based on the predicted pupil position; and
generating an eye-socket image by cropping and resizing the event image based on the predicted eye-socket position.

15. The non-transitory computer readable storage medium of claim 14, wherein training the gaze-estimation machine learning model comprises:
training a second feature-extraction neural network to extract a second set of features from the pupil image; and
training a third feature-extraction neural network to extract a third set of features from the eye-socket image.

16. The non-transitory computer readable storage medium of claim 15, wherein the method further comprises:
concatenating the second and third sets of features;
inputting the concatenated second and third sets of features to a fourth feature-extraction neural network; and
training the fourth feature-extraction neural network to extract a fourth set of features used for predicting the direction of the user's eye moment.

17. The non-transitory computer readable storage medium of claim 16, wherein the method further comprises:
concatenating the second, third, and fourth sets of features;
inputting the concatenated second, third, and fourth sets of features to a fifth feature-extraction neural network; and
training the fifth feature-extraction neural network to extract a fifth set of features used for predicting the speed of the user's eye moment.

18. A computer system, comprising:
a processor; and
a storage device coupled to the processor, wherein the storage device storing instructions which, when executed by the processor, cause the processor to perform a method, the method comprising:
obtaining an event stream captured by an event camera monitoring movement of a user's eye;
generating an event image by accumulating, at a pixel level, events that occurred within a predetermined interval based on the event stream and determining a pixel value of each pixel based on the accumulated events associated with the pixel; and
inputting the event image to a gaze-estimation machine learning model, which generates a first prediction output regarding a direction of the user's eye movement and a second prediction output regarding a speed of the user's eye movement.

19. The computer system of claim 18,
wherein the method further comprises training the gaze-estimation machine learning model using a plurality of annotated event images;
wherein a respective annotated event image comprises position annotations and movement annotations;
wherein the position annotations indicate a pupil position, an eye-socket position, and positions of eye corners; and
wherein the movement annotations indicate a direction and a speed.

20. The computer system of claim 19, wherein training the gaze-estimation machine learning model comprises:
training a first feature-extraction neural network to extract a first set of features used for predicting the pupil position and the eye-socket position;
generating a pupil image by cropping and resizing the event image based on the predicted pupil position;
generating an eye-socket image by cropping and resizing the event image based on the predicted eye-socket position;
training a second feature-extraction neural network to extract a second set of features from the pupil image;
training a third feature-extraction neural network to extract a third set of features from the eye-socket image;
concatenating the second and third sets of features;
inputting the concatenated second and third sets of features to a fourth feature-extraction neural network;
training the fourth feature-extraction neural network to extract a fourth set of features used for predicting the direction of the user's eye moment;
concatenating the second, third, and fourth sets of features;
inputting the concatenated second, third, and fourth sets of features to a fifth feature-extraction neural network; and
training the fifth feature-extraction neural network to extract a fifth set of features used for predicting the speed of the user's eye moment.
